(19) United States
(12) Patent Application Publication
(10) Pub. No.: US 2026/0062993 A1
(43) Pub. Date: Mar. 5, 2026

(54) SHEER VERTICAL BLIND STRUCTURE

(71) Applicant: CHING FENG HOME FASHIONS CO., LTD., FU HSIEN (TW)

(72) Inventor: WEN-YING LIANG, Lukang Township (TW)

(73) Assignee: CHING FENG HOME FASHIONS CO., LTD., FU HSIEN (TW)

(21) Appl. No.: 18/825,109

(22) Filed: Sep. 5, 2024

(51) Int. Cl. E06B 9/36; E06B 9/262

(52) U.S. Cl. CPC E06B 9/362; E06B 9/262; E06B 2009/2622

(57) ABSTRACT

A sheer vertical blind structure includes a plurality of sliding carriers provided in an elongated headrail. Each sliding carrier is protrudingly provided thereunder with a clamping base. Each clamping base includes a central plate portion and two clamping and fastening portions. Each clamping and fastening portion has one end extending away from the headrail such that a clamping groove with a downward-facing opening is formed between each clamping and fastening portion and the corresponding central plate portion. Each clamping and fastening portion is provided with an engaging hook protruding toward the corresponding central plate portion. Each sliding carrier is configured to work with two clamping plates. Each clamping plate has an inner side and an outer side, wherein the outer side is provided with an engaging groove.

### BACKGROUND OF THE INVENTION

### 1. Technical Field

The present invention relates to the hanging structure for a curtain/blind fabric. More particularly, the invention relates to a sheer vertical blind structure.

### 2. Description of Related Art

A conventional hanging structure for a curtain/blind fabric is shown in FIG. 1 to FIG. 4. Such a hanging structure is used with common vertical fabric vanes and generally includes a headrail 1. The headrail 1 is provided therein with a plurality of sliding carriers 2, and each sliding carrier 2 is pivotally provided thereunder with a hanging portion 3 that extends downward. Each hanging portion 3 is provided with two hanging hooks 4, and each hanging hook 4 defines an upward-facing opening. In addition, each sliding carrier 2 is configured to work with a pair of elongated clamping plates 5. The upper edge of each clamping plate 5 is provided with a hanging hole 6, and each pair of clamping plates 5 is configured to be clamped to the two opposite sides of a fabric vane 7 or of the overlapping portion of two adjacent fabric vanes 7 and hung on the hanging hooks 4 of the hanging portion 3 of the corresponding sliding carrier 2. The operation and movement of the sliding carriers 2 are not what the present invention is intended to improve and therefore will not be described any further.

This conventional structure provides the basic function of hanging fabric vanes but still leaves something to be desired. As the operation of the conventional structure requires a hanging action, each hanging portion 3 must have a sufficient downward extension length so that the space between the hanging holes 6 of each pair of clamping plates 5 and the lower edge of the headrail 1 is large enough for the pair of clamping plates 5 to be moved upward beyond the upper edges of the corresponding hanging hooks 4 and then moved downward in order to be hung on the corresponding hanging hooks 4. Such a structure and operation, however, result in a large gap between the upper edge of each clamping plate 5 and the lower edge of the headrail 1 as shown in FIG. 2, and the gap causes leakage of light along the top edge of the curtain/blind.

### BRIEF SUMMARY OF THE INVENTION

The primary objective of the present invention is to provide a sheer vertical blind structure that is easy to operate and can reduce leakage of light.

To achieve the primary objective, the sheer vertical blind structure of the present invention includes a plurality of sliding carriers provided in an elongated headrail, and each sliding carrier is protrudingly provided thereunder with a clamping base that includes a central plate portion and two clamping and fastening portions. Each clamping and fastening portion has one end connected to the corresponding central plate portion and the opposite end extending away from the headrail such that a clamping groove with a downward-facing opening is formed between each clamping and fastening portion and the corresponding central plate portion. Moreover, each clamping and fastening portion is provided with an engaging hook that protrudes toward the corresponding central plate portion. Each sliding carrier is configured to work with two clamping plates. Each clamping plate has an inner side and an outer side. The inner side of each clamping plate is provided with a plurality of protruding coupling portions, and the outer side of each clamping plate is provided with an engaging groove that extends from the outer side toward the inner side of the clamping plate. Each clamping plate can be inserted into the corresponding clamping groove such that the corresponding engaging hook is engaged in the engaging groove of the clamping plate.

Thanks to the foregoing structures, the sheer vertical blind structure of the present invention allows each clamping base and the corresponding clamping plates to be fitted together and use the same space so that the distance between the upper edge of each clamping plate and the lower edge of the headrail can be shortened to reduce leakage of light along the top edge of the blind.

### BRIEF DESCRIPTION OF THE SEVERAL VIEWS OF THE DRAWINGS

FIG. 1 is a perspective view of a conventional product.

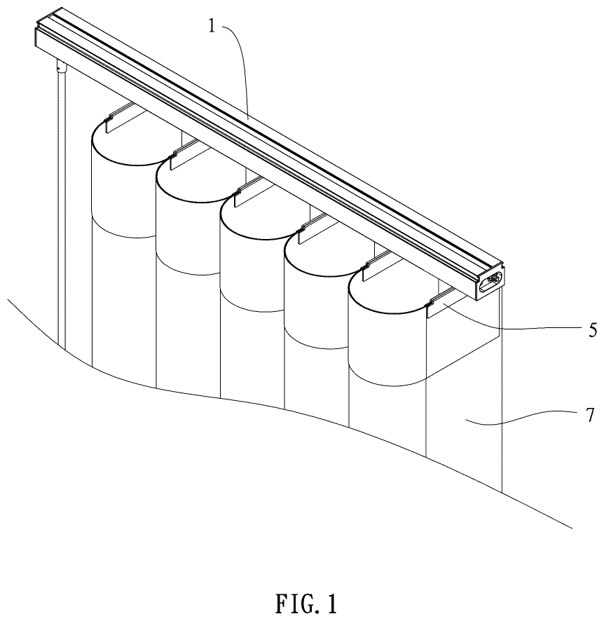

FIG. 2 is a side view of the conventional product in FIG. 1.

FIG. 3 is an exploded perspective view of the conventional product in FIG. 1.

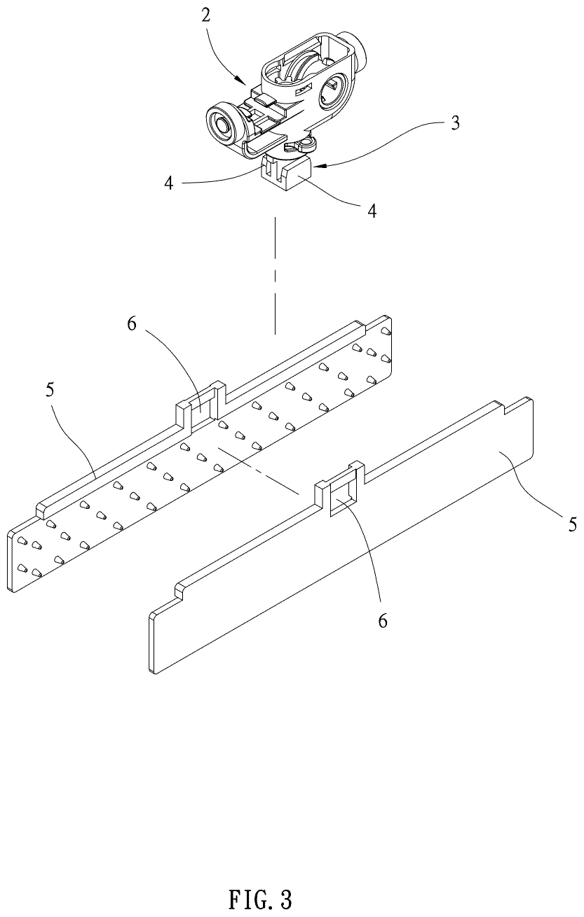

FIG. 4 is a front view of a sliding carrier and the corresponding clamping plates in the conventional product in FIG. 1.

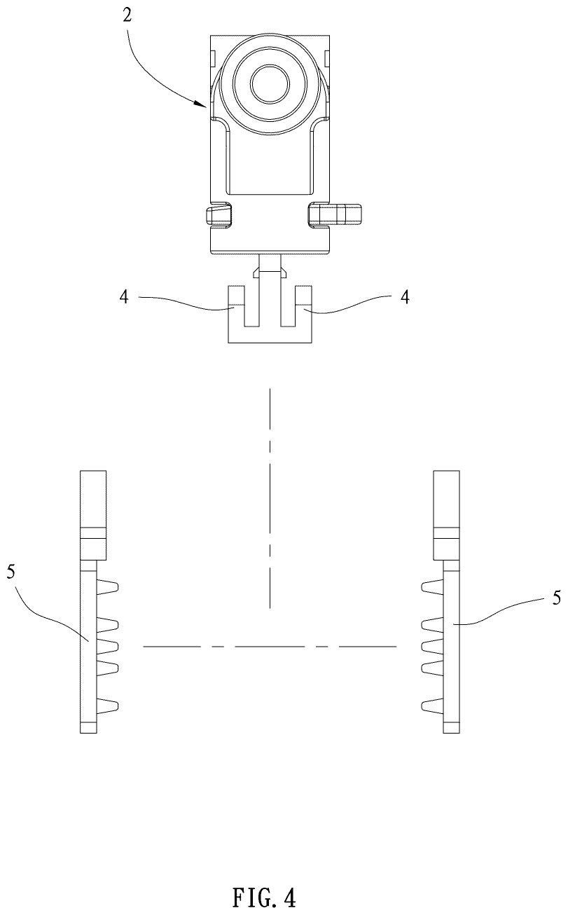

FIG. 5 is a side view of the present invention.

FIG. 6 is an exploded perspective view of the present invention.

FIG. 7 is a front view of the present invention.

FIG. 8 shows the inner side of a clamping plate in the present invention.

FIG. 9 shows the outer side of a clamping plate in the present invention.

FIG. 10 is a sectional view of the present invention.

### DETAILED DESCRIPTION OF THE INVENTION

To begin with, the applicant would like to point out that, throughout this specification, including the following description of an embodiment and the appended claims, all the directional terms make reference to the directions shown in the accompanying drawings. In addition, in the following embodiment and the drawings, identical or similar elements or structural features are designated by the same reference numeral. Furthermore, the directions stated herein refer to those in the drawings only to facilitate description and are not limiting.

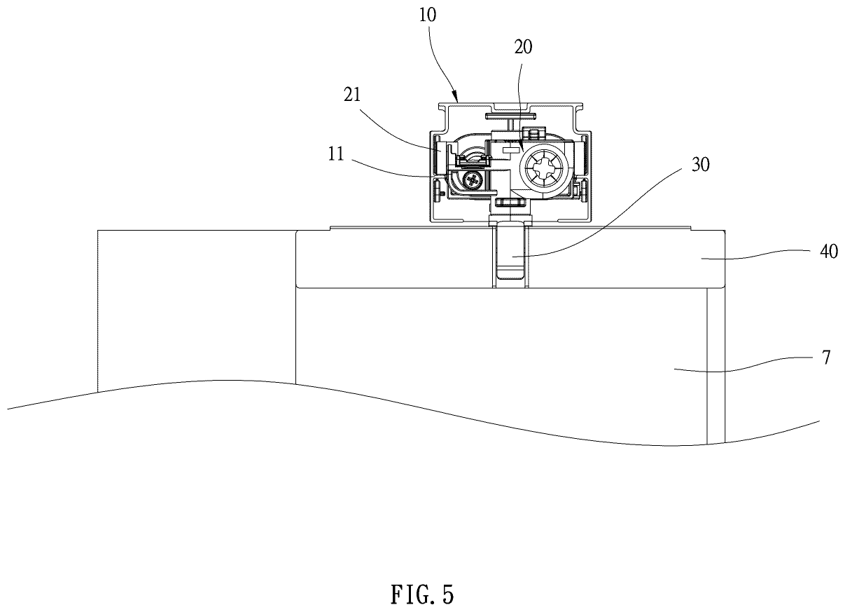

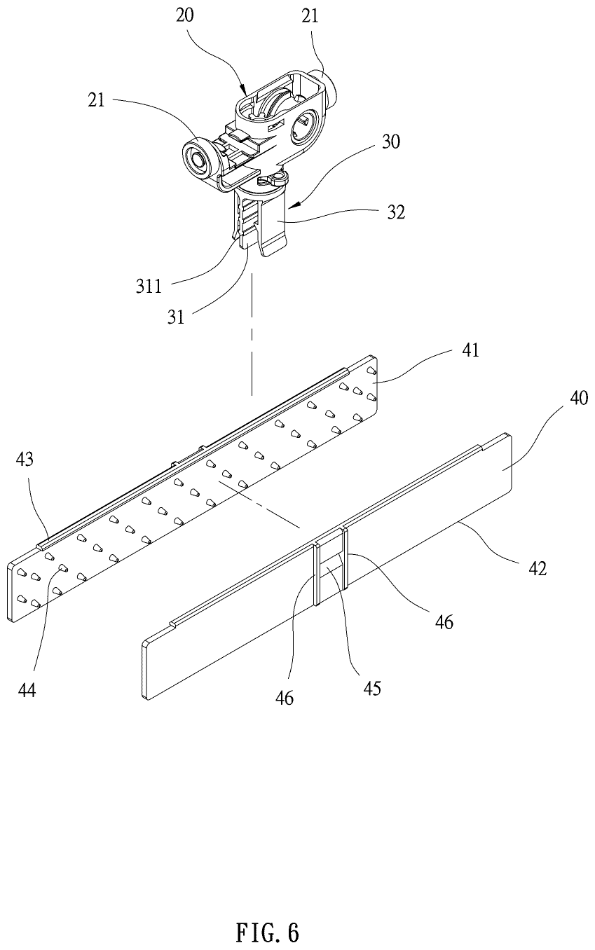

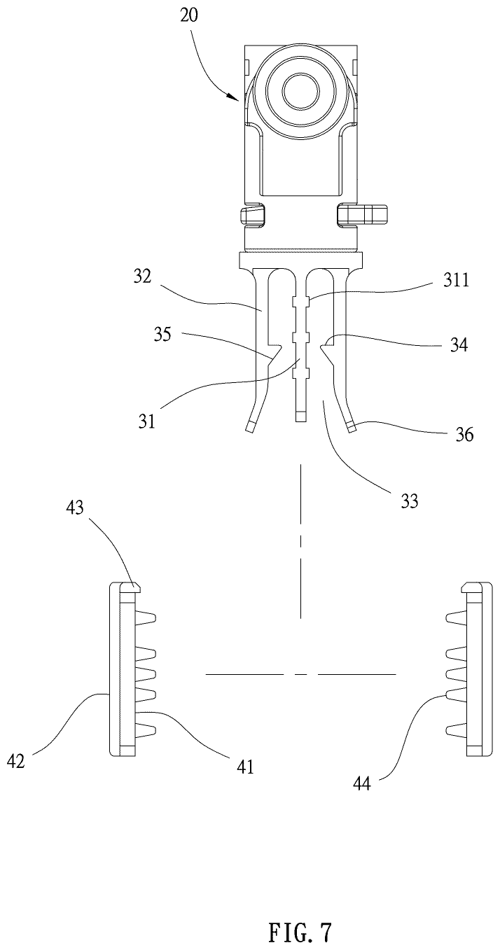

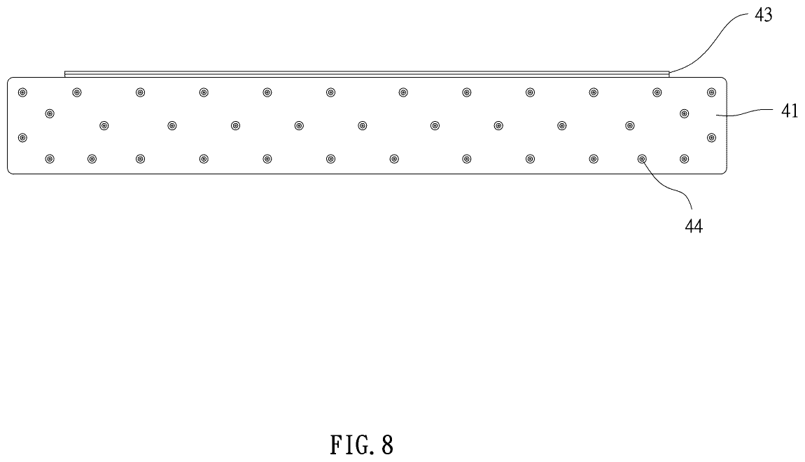

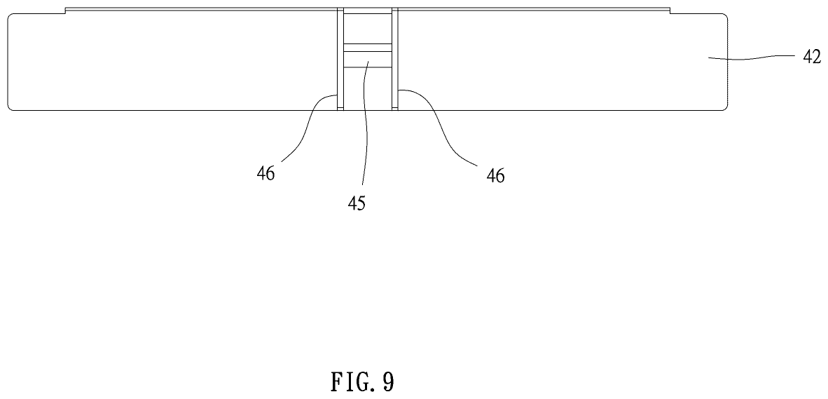

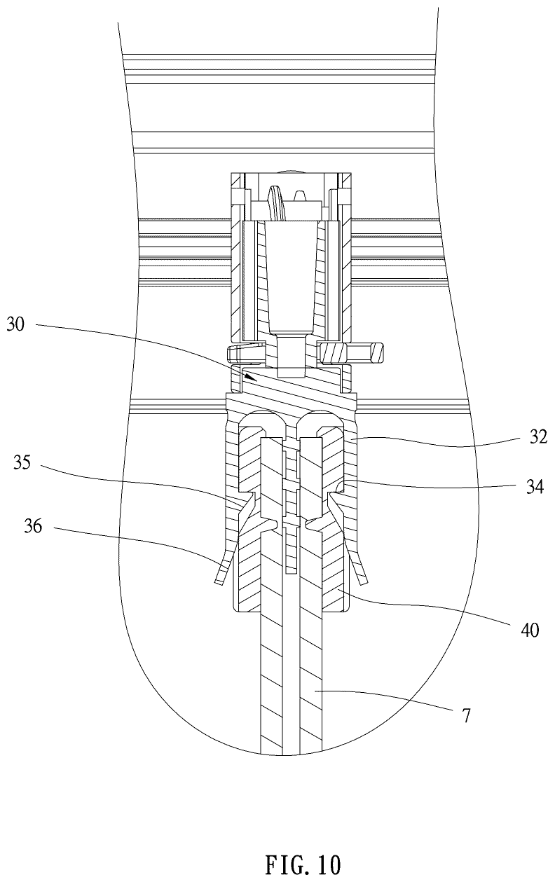

Referring to FIG. 5 to FIG. 10, the sheer vertical blind structure of the present invention includes a headrail 10 and a plurality of sliding carriers 20.

The headrail 10 has an elongated shape and is provided therein with two rolling rails 11 extending along the length direction of the headrail 10.

Each sliding carrier 20 includes two rollers 21 each provided on one of two opposite sides of the sliding carrier 20. The sliding carriers 20 are provided in the headrail 10 and are configured to be moved along the two rolling rails 11 of the headrail 10. The headrail 10 and the sliding carriers 20 may use the headrail and sliding carrier structures of a conventional curtain/blind, and the way in which the sliding carriers 20 are moved may be controlled via a cord or by power transmission through a rotating shaft. The present invention has no limitation on how the sliding carriers 20 are moved, and no further description will be provided herein for such conventional structures as the headrail 10 and the sliding carriers 20.

The present invention is characterized by the following technical features.

Each sliding carrier 20 is pivotally provided thereunder with a clamping base 30 that extends downward, and each clamping base 30 includes a central plate portion 31 and two clamping and fastening portions 32.

Each central plate portion 31 is in the shape of a plate and has two opposite sides each provided with a plurality of anti-slip strips 311. The clamping and fastening portions 32 of each clamping base 30 extend outward from the two opposite sides of the corresponding central plate portion 31, with one end of each clamping and fastening portion 32 connected to the corresponding central plate portion 31, and the other end of each clamping and fastening portion 32 extending away from the headrail 10 such that a clamping groove 33 with a downward-facing opening is formed between each clamping and fastening portion 32 and the corresponding central plate portion 31. Each clamping and fastening portion 32 is provided with an engaging hook 34 that protrudes toward the corresponding central plate portion 31. Each engaging hook 34 has an inclined first inward guiding surface 35, and the distal section of each clamping and fastening portion 32 is bent outward to form a second inward guiding surface 36.

Each sliding carrier 20 is configured to work with two clamping plates 40. Each clamping plate 40 has an inner side 41 and an outer side 42. The upper edge of the inner side 41 of each clamping plate 40 is provided with a protruding stop wall 43 to facilitate the positioning of the fabric vane to be coupled to the clamping plate 40. The inner side 41 of each clamping plate 40 is provided with a plurality of protruding coupling portions 44. The outer side 42 of each clamping plate 40 is provided with an engaging groove 45 that extends from the outer side 42 toward the inner side 41 of the clamping plate 40. The outer side 42 of each clamping plate 40 is further provided with two protruding guiding walls 46, with the engaging groove 45 of the clamping plate 40 located between the two protruding guide walls 46, and the distance between the two protruding guide walls 46 being greater than or equal to the width of the corresponding clamping and fastening portion 32 in order for the two protruding guiding walls 46 to produce a position-limiting effect on the corresponding clamping and fastening portion 32.

The foregoing structures of the present invention allow the invention to be used in the following manner. As in a conventional product, the sliding carriers 20 are installed in the headrail 10, and the inner sides 41 of each pair of clamping plates 40 are each coupled to the upper edge of a fabric vane 7 in such a way that the lower edge of the stop wall 43 of each clamping plate 40 is precisely in contact with the upper edge of the corresponding fabric vane 7. By bringing the lower edge of each stop wall 43 precisely into contact with the upper edge of the corresponding fabric vane 7 during installation, a positioning function is carried out for each fabric vane 7, making it possible to install all the fabric vanes 7 at the same height.

After that, each clamping plate 40 together with the corresponding fabric vane 7 is inserted upward into the corresponding clamping groove 33 of the corresponding clamping base 30. During the insertion process, each clamping plate 40 and the corresponding fabric vane 7 are moved along the corresponding second inward guiding surface 36 and thus push the corresponding clamping and fastening portion 32 outward to facilitate entry into the corresponding clamping groove 33. When each clamping plate 40 is pushed against the corresponding first inward guiding surface 35, the corresponding clamping and fastening portion 32 is pushed slightly further outward. When the engaging groove 45 of each clamping plate 40 corresponds in position to the corresponding engaging hook 34, the corresponding engaging hook 34 is engaged in the engaging groove 45 and therefore works together with the corresponding central plate portion 31 to fixedly clamp the clamping plate 40 and the corresponding fabric vane 7 in position, with the corresponding clamping and fastening portion 32 located between the two protruding guide walls 46 of the clamping plate 40. Thus, each clamping plate 40 uses its engaging groove 45 and two protruding guide walls 46 to fixedly engage with the corresponding clamping and fastening portion 32.

Another function of the second inward guiding surfaces 36 is that their outwardly bent configuration allows a user to remove the clamping plates 40 and the fabric vanes 7 with ease. A user wishing to remove a clamping plate 40 and the corresponding fabric vane 7 only has to push the corresponding second inward guiding surface 36 outward to move the corresponding clamping and fastening portion 32 farther away from the corresponding central plate portion 31, and the corresponding engaging hook 34 will be disengaged from the engaging groove 45 of the clamping plate 40 to allow the clamping plate 40 and the corresponding fabric vane 7 to be taken out.

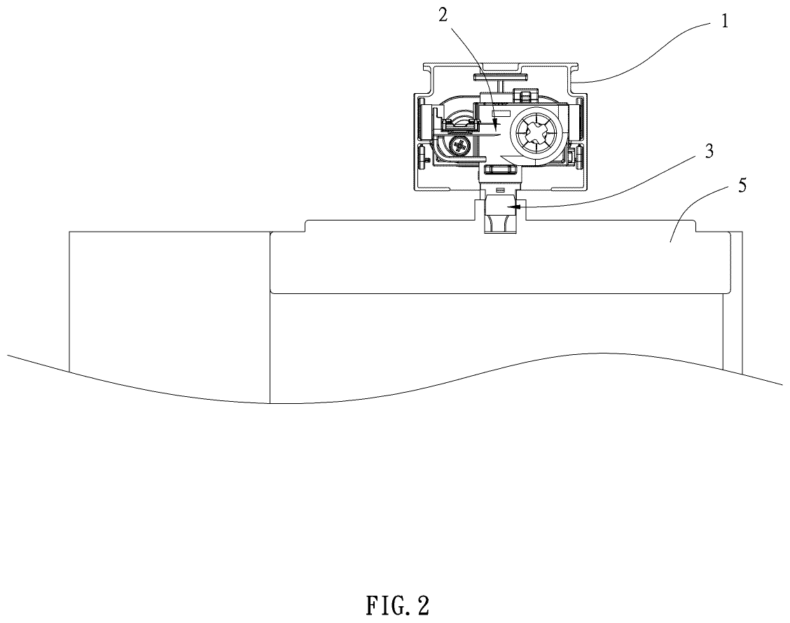

The present invention is so structured that each clamping plate 40 and the corresponding fabric vane 7 are coupled to the corresponding clamping base 30 directly by an upward insertion and engaging operation. Therefore, there is no need to reserve a space between the upper edge of each clamping plate 40 and the lower edge of the headrail 10; that is to say, the downward extension length of each clamping base 30 can be greatly reduced. Moreover, once a clamping plate 40 is engaged in the corresponding clamping groove 33, the clamping plate 40 and the corresponding clamping and fastening portion 32 are of the same height; in other words, the upper edge of a clamping plate 40 fitted in the corresponding clamping base 30 can be as close to the lower edge of the headrail 10 as possible. It can be seen in a comparison between FIG. 2 and FIG. 5 that the gap in the conventional product between the lower edge of the headrail 1 and the upper edge of a clamping plate 5 has been eliminated in the present invention to effectively improve the prior art problem of leakage of light and thereby achieve the objective of the invention.

What is claimed is:

1. A sheer vertical blind structure, comprising:
a headrail of an elongated shape; and
a plurality of sliding carriers provided in the headrail and movable along a length direction of the headrail, wherein each said sliding carrier has two opposite sides and comprises two rollers each provided on one of the two opposite sides;
the sheer vertical blind structure being characterized in that:
a clamping base extends downward from each said sliding carrier, and each said clamping base comprises a central plate portion and two clamping and fastening portions;
each said clamping and fastening portion extends outward from one of two opposite sides of a corresponding said central plate portion, each said clamping and fastening portion has one end connected to the corresponding central plate portion and an opposite end extending away from the headrail such that a clamping groove with a downward-facing opening is formed between each said clamping and fastening portion and the corresponding central plate portion, and each said clamping and fastening portion is provided with an engaging hook protruding toward the corresponding central plate portion; and
each said sliding carrier is configured to work with two clamping plates, each said clamping plate has an inner side and an outer side, the inner side of each said clamping plate is provided with a plurality of protruding coupling portions, and the outer side of each said clamping plate is provided with an engaging groove extending from the outer side toward the inner side of the each said clamping plate.

2. The sheer vertical blind structure of claim 1, wherein the inner side of each said clamping plate has an upper edge provided with a protruding stop wall.

3. The sheer vertical blind structure of claim 1, wherein each said clamping and fastening portion has a distal section bent outward to form a second inward guiding surface.

4. The sheer vertical blind structure of claim 2, wherein each said clamping and fastening portion has a distal section bent outward to form a second inward guiding surface.

5. The sheer vertical blind structure of claim 1, wherein the outer side of each said clamping plate is provided with two protruding guide walls, and the engaging groove of each said clamping plate is located between the two protruding guide walls of the each said clamping plate.

6. The sheer vertical blind structure of claim 4, wherein the outer side of each said clamping plate is provided with two protruding guide walls, and the engaging groove of each said clamping plate is located between the two protruding guide walls of the each said clamping plate.

7. The sheer vertical blind structure of claim 5, wherein a distance between the two protruding guide walls of each said clamping plate is greater than or equal to a width of a corresponding said clamping and fastening portion.

8. The sheer vertical blind structure of claim 6, wherein a distance between the two protruding guide walls of each said clamping plate is greater than or equal to a width of a corresponding said clamping and fastening portion.

9. The sheer vertical blind structure of claim 1, wherein each of the two opposite sides of each said central plate portion is provided with a plurality of anti-slip strips.

10. The sheer vertical blind structure of claim 1, wherein each said engaging hook has an inclined first inward guiding surface.
